(19) United States
(12) Patent Application Publication
(10) Pub. No.: US 2010/0205242 A1
(43) Pub. Date: Aug. 12, 2010

(54) FRIEND-FINDING SYSTEM

(75) Inventors: Thomas L. Marchioro, II, Kansas City, MO (US); Benjamin E. Jones, Overland Park, KS (US); Nicholas S. Grimsley, Overland Park, KS (US); Ye Su, Overland Park, KS (US)

Correspondence Address: GARMIN LTD.;C/O GARMIN INTERNATIONAL, INC., ATTN: Legal - IP, 1200 EAST 151ST STREET, OLATHE, KS, 66062, US

(73) Assignee: GARMIN LTD., Camana Bay (KY)

(21) Appl. No.: 12/480,470

(22) Filed: Jun. 8, 2009

Related U.S. Application Data
(60) Provisional application No. 61/151,879, filed on Feb. 12, 2009.

(51) Int. Cl. G06F 15/16

(52) U.S. Cl. 709/203; 709/204; 709/218

(57) ABSTRACT

Techniques are described to exchange location information between a location-aware client device and friend devices via a server that is configured to communicate with one or more friend finding services. The server may reformat the location information for communication between the client device and the friend finding services when the location information is provided in a format that is not supported by one or more of the client device, the friend device, or the one or more friend finding services.

### CROSS-REFERENCE TO RELATED APPLICATIONS

The present application claims the benefit under 35 U.S.C. § 119(e) of U.S. Provisional Application Ser. No. 61/151,879, filed Feb. 12, 2009, which is herein incorporated by reference in its entirety.

### BACKGROUND

Location-aware devices, including navigation devices, mobile phones, portable computing devices, and various other Global Positioning System (GPS) equipped consumer electronic devices are becoming increasingly popular. Location-aware devices make it possible for users of the devices to determine their location quickly and easily. Once acquired, the user's location may be used by the device to provide location-based functionality to the user. For example, a location-aware device may use location information to find local points of interest such as restaurants, stores, service stations, attractions, and so forth.

The location of the user may be periodically updated by the location-aware device as the user moves about. Periodic updating of location information may be used by the location-aware device to provide additional functionality such as navigation and updating of local points of interests.

### SUMMARY

Techniques are described to exchange location information between a location-aware client device and friend devices via a server that is configured to communicate with one or more friend finding services. The server may reformat the location information for communication between the client device and the friend finding services when the location information is provided in a format that is not supported by one or more of the client device, the friend device, or the friend finding services.

In one implementation, location information for a friend device is received from a friend finding service. A determination is made whether the format of the location information is supported by the client device. When the format of the location information is determined to not be supported by the client device, the location information may be reformatted to a format that is supported by the client device. Similarly, location information may be received from the client device to be furnished to a friend device via a friend finding service. A determination is made whether the format of the location information is supported by the friend finding service. When the format of the location information is determined to not be supported by the friend finding service, the location information may be reformatted to a format that is supported by the friend finding service.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to exchange location information between a client device and friend devices through one or more friend finding services.

FIG. 2 is an illustration depicting example functionality provided by a server, in cooperation with a client device, of the environment shown in FIG. 1.

FIG. 3 is a flow diagram depicting a procedure in an example implementation in which location information for a friend device is retrieved from one or more friend finding services and furnished to a client device.

FIG. 4 is a flow diagram depicting a procedure in an example implementation in which location information for a client device is furnished to a friend device via one or more friend finding services.

FIG. 5 is a flow diagram depicting a procedure in an example implementation in which friend devices may be located on one or more friend finding services.

FIG. 6A is an illustration depicting an example user interface of a client device, such as the client device shown in FIG. 1, in which a location of a friend device is shown on a map display provided by the user interface.

FIG. 6B is an illustration depicting the example user interface shown in FIG. 6A, further illustrating an example configuration of the map display.

FIG. 7 is an illustration depicting the example user interface of a client device, such as the client device shown in FIG. 1, in which a list of friend devices is displayed.

FIG. 8 is an illustration depicting an example user interface of a client device, such as the client device shown in FIG. 1, in which information is displayed describing a friend device selected from the list of the friend devices shown in FIG. 7.

FIG. 9 is an illustration depicting an example user interface of a client device, such as the client device shown in FIG. 1, in which a map is displayed that describes the area surrounding a friend device described by the information displayed by the user interface shown in FIG. 8.

FIG. 10 is an illustration depicting an example user interface of a client device, such as the client device shown in FIG. 1, in which the status of the client device is displayed.

### DETAILED DESCRIPTION

### Overview

Location-aware devices may employ a variety of location determining techniques that make it possible for users to ascertain location information describing the location of the location-aware device, and thus the location of a user of the location-aware device. This location information may then be shared with other devices through a wireless network. For example, users of location-aware devices may subscribe to a friend finding service through the device's service provider. The friend finding service may allow the user to exchange location information with other users of the network. In this manner, the user may view the locations of other location-aware device equipped individuals. However, friend finding services often employ network-specific client software that is not compatible with other friend finding services. Thus, the user may not be able to exchange location information with friends that subscribe to a different friend finding service.

Accordingly, techniques are described to exchange location information between a location-aware client device and one or more friend devices. In an implementation, a server is configured to communicate the location information with the friend devices through one or more friend finding services. For example, the server may communicate with a plurality of discrete and diverse friend finding services to exchange location information regarding various friend devices and the location-aware client device. The location-aware client device is operable to communicate with the server though a network to provide location information to the server. The location information may include information such as the current location (e.g., geographic coordinate, mailing address, nearby point of interest, etc.) of the client device, the status of the user, and so forth. In embodiments, the client device may automatically push location information to the server at various intervals or in response to a manual input by a user of the client device.

In the following discussion, an example environment is first described that is operable to perform the techniques to provide location information and/or friend information for users of client and friend devices. Exemplary procedures are then described which may be employed in the exemplary environment, as well as in other environments without departing from the spirit and scope thereof.

Example Environment

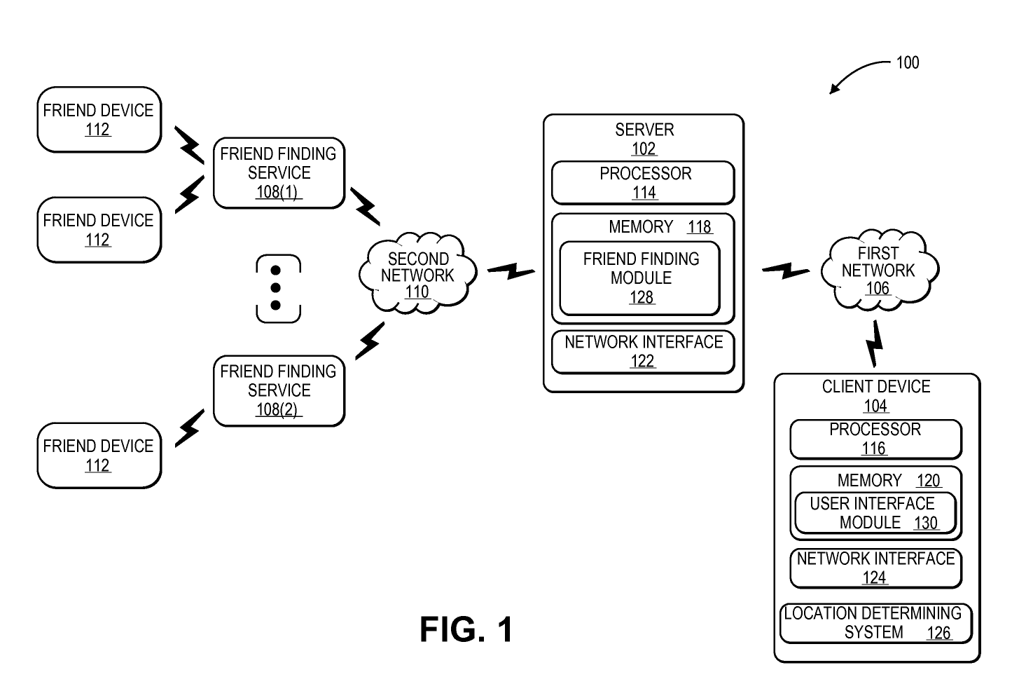

FIG. 1 illustrates an environment 100 in an example implementation that is operable to facilitate the exchange of location information between a location-aware client device and one or more friend devices through various friend finding services. The illustrated environment 100 includes a server 102 and a client device 104 that communicates with the server 102 via a network 106. The server 102 is configured to communicate with a plurality of discrete and diverse friend finding services 108 via a second network 110 to exchange location information regarding various friend devices 112 and the client device 104.

The server 102 may be configured in a variety of ways. For example, the server 102 may be configured as a server computer that is capable of communicating over a wired or wireless network. In one implementation, the server 102 may be one or more server computers that provide access to the friend-finding services to client devices 104 via the network 106.

The client device 104 may also be configured in a variety of ways. For example, the client device 104 may be configured as a location-aware device such as a navigation device, a mobile phone (e.g., a smart phone, a cell phone, etc.), a portable media player, a mobile internet device, a netbook, a portable computing device, and so forth that is capable of communicating over a wireless network. The client device 104 may also be configured as a computer such as a desktop or laptop computer that is capable of communicating over a wired or wireless network. Thus, the client device 104 may range from a full resource device with substantial memory and processor resources (e.g., a personal computer) to low-resource devices with limited memory and/or processing resources (e.g., a cell phone). Additionally, although one client device 104 is illustrated, it is to be understood that the server 102 may provide the functionality described herein to multiple client devices 104.

The networks 106 & 110 may assume a wide variety of configurations. For example, the networks 106 & 110 may include a wide-area cellular telephone network such as a 3G cellular network, a wireless network (e.g., a WIFI (IEEE 802.11) network), the Internet, a wide area network (WAN), a local area network (LAN), a public telephone network, an extranet, an intranet, and so on. In an implementation, the networks 106 & 110 may comprise a common network or the same network, such as a common 3G cellular network. In other implementations, the networks 106 & 110 may comprise separate networks (e.g., network 106 comprises a 3G cellular network, while network 110 comprises the Internet). Networks 106 & 110 may also be configured to include multiple networks. The client device 104 is configured to communicate with the server 102 though the network 106 to provide client location information to the server 102. The client device 104 may provide a variety of location information to the server 102, including the current location (e.g., geographic coordinate, mailing address, nearby point of interest, heading, speed, and so on) of the client device 104, the status of the user of the client device 104 (e.g., a user-created message indicating current activity), navigation information associated with the client device 104 (e.g., a current route, an intended destination, a previous location or route, etc.), and so on.

In embodiments, the client device 104 may automatically push location data to the server 102 at various intervals. The client device 104 may also push location information to the server 102 in response to a manual input by a user of the client device 104. The client device 104 may push location information to the server 102 at any time. For example, the client device 104 may push the device's location information to the server 102 as part of a call or other telecommunication event through the network 106 to the friend devices 112, at predetermined intervals, at random intervals (regardless of whether a call or telecommunication event is occurring), and so on. The device may also push the device's location information to the server 102 as the result of a navigation event, such as reaching a route destination, a point of interest, a waypoint, and the like.

The friend finding services 108(1), 108(2) may be configured in a number of ways. Friend finding services 108 may comprise social networks, navigation networks, mapping networks, communications networks, and so on. Example friend finding services 108 include the ULOCATE (uLocate Communications Inc., Boston Mass.), GYPSII (GeoSolutions B.V., Amsterdam, Netherlands), and GOOGLE LATITUDE friend finding services. The friend finding services 108 are configured to provide location information for a plurality of friend devices 112. The friend finding services 108 and friend devices 112 may communicate in any manner to establish friend location information for the friend devices 112 and store the established location information on one or more of the friend finding services 108.

The friend devices 112 may have diverse configurations. In embodiments, one or more of the friend devices 112 may have a configuration that is similar to the configuration of the client device 104. Each friend device 112 may comprise an electronic device that is configured to communicate with one or more friend finding services 108 to establish the respective location of the friend devices. Friend devices 112 may comprise location-aware devices or location-unaware devices including, but not limited to, desktop personal computers, portable computing devices, netbooks, mobile internet devices, navigation devices, mobile phones (e.g., smart phones, cellular phones, etc.), wearable electronic devices, or combinations thereof. In some embodiments, the friend device(s) 112 and server 102 may be adapted to communicate without the participation of the various friend finding services 108. For example, the server 102 may itself translate friend information, and other content, for use by the various devices 104, 112.

In FIG. 1, the server 102 and the client device 104 are illustrated as including a respective processor 114 or 116; a respective memory 118 or 120; and a respective network interface 122 or 124. In the following discussion, elements of the server 102 are described with reference to FIG. 1. Respective elements and/or reference numbers related of the client device 104 are shown in parentheses. Where appropriate, elements of the client device 104 are described separately.

The processor 114 (116) provides processing functionality for the server 102 (client device 104) and may include any number of processors, micro-controllers, or other processing systems and resident or external memory for storing data and other information accessed or generated by the server 102 (client device 104). The processor 114 (116) may execute one or more software programs which implement techniques described herein. The processor 114 (116) is not limited by the materials from which it is formed or the processing mechanisms employed therein, and as such, may be implemented via semiconductor(s) and/or transistors (e.g., electronic integrated circuits (ICs)), and so forth.

The memory 118 (120) is an example of tangible computer-readable media that provides storage functionality to store various data associated with the operation of the server 102 (client device 104), such as the software program and code segments mentioned above, or other data to instruct the processor 114 (116) and other elements of the server 102 (client device 104) to perform the steps described herein. Although a single memory 118 (120) is shown, a wide variety of types and combinations of memory may be employed. The memory 118 (120) may be integral with the processor 114 (116), stand-alone memory, or a combination of both. The memory may include, for example, removable and non-removable memory elements such as RAM, ROM, Flash (e.g., SD Card, mini-SD card, micro-SD Card), magnetic, optical, USB memory devices, and so forth. In embodiments of the client device 104, the memory 120 may include removable ICC (Integrated Circuit Card) memory such as provided by SIM (Subscriber Identity Module) cards, USIM (Universal Subscriber Identity Module) cards, UICC (Universal Integrated Circuit Cards), and so on.

The network interface 122 (124) provides functionality to enable the server 102 (client device 104) to communicate with one or more networks, such as networks 106 and/or 110 of FIG. 1. In various implementations, the network interface 122 (124) may include a variety of components such as modems, routers, wireless access points, cellular telephone transceivers, and so forth, and any associated software employed by these components (e.g., drivers, configuration software, and so on). In FIG. 1, the network interface 122 (124) is illustrated as being an internal component of the server 102 (client device 104). However, in some implementations, one or more components of the network interface 122 (124) may be external components communicatively coupled to the server 102 (client device 104) via a wired or wireless connection.

The client device 104 further includes a location determining system 126 configured to provide location determining functionality for the client device 104. Location-determining functionality, for purposes of the following discussion, may relate to a variety of different navigation techniques and other techniques that may be supported by “knowing” one or more locations. For instance, location-determining functionality may be employed to provide location data, timing data, speed data, and a variety of other navigation-related data.

In implementations, the location determining system 126 may comprise a receiver that is configured to receive signals from one or more position-transmitting sources. For example, the location determining system 126 may be configured for use with a Global Navigation Satellite system (GNSS). In embodiments, the location determining system 126 may be a global positioning system (GPS) receiver operable to receive navigational signals from GPS satellites and to calculate a location of the client device 104 as a function of the signals.

While a GPS system is described in this document, it is contemplated that a wide variety of other positioning systems may also be used, such as terrestrial based systems (e.g., wireless-telephony systems or data systems that broadcast position data from cellular towers), wireless networks that transmit positioning signals, and so on. For example, positioning-determining functionality may be implemented through the use of a server in a server-based architecture, from a ground-based infrastructure, through one or more sensors (e.g., gyros or odometers), and so on. Other exemplary systems include, but are not limited to, a Global Orbiting Navigation Satellite System (GLONASS), a Galileo navigation system, or other satellite navigation system. Location may additionally or alternatively be determined by performing a point of interest search via onboard data or through an internet search and then using the location of one or more selected points of interest.

The client device 104 may be configured to perform a variety of navigation related functions. For example, the client device 104 may be configured for vehicle navigation, pedestrian navigation, aerial navigation (e.g., for aircraft, helicopters, and so on), marine navigation, personal use (e.g., a mobile device, as a part of fitness-related equipment), and so forth. Accordingly, the client device 104 may include multiple location determining systems 126 to determine the location of the device 104 using a variety of the techniques as described above.

As illustrated in FIG. 1, the server 102 may include a friend finding module 128, which may be implemented as a software application stored in memory 118 and executed by the processor 114 of the server 102. The friend finding module 128 is representative of functionality to exchange location information between the client device 104 and the friend devices 112. In some embodiments, the friend finding module 128 itself may provide a friend finding service, such as where the various friend devices 112 and client device 104 are each operable to communicate with the server 102. Additionally or alternatively, the friend finding module 128 may use one or more of the friend finding services 108 to provide friend-finding services to the client device 104.

In implementations, the friend finding module 128 is operable to provide an interface between the client device 104 and the friend finding services 108 regardless of the data formats employed by the various friend finding services 108. Thus, the friend finding module 128 may acquire friend location information from any one or more of the friend finding services 108 and format the location information for use by the client device 104. Such functionality enables the client device 104 to acquire information regarding the location of the friend devices 112 regardless of the particular friend finding service 108 used by the friend devices 112.

In embodiments, one or more of the friend finding services 108 may utilize unsophisticated location information (e.g., a mailing address, a general location such as a restaurant name, intersection, neighborhood, city, etc.). The friend finding module 128 may convert the unsophisticated location information into precise location information (geocoded information, coordinate information representing a particular discrete location on the Earth, etc) for use by the client device 104. Such functionality enables the user to use the sophisticated navigation functionality (e.g., routing, navigation, mapping, etc.) which may be provided by the client device 104 even when the user's friends are associated with services 108 and devices 112 that are unable to employ sophisticated location information.

For example, the friend finding module 128 may perform map matching and/or other location-conversion functionality to provide a uniform friend interface for the client device 104. Map matching functionality may include, for example, associating a coordinate with a geographical feature such as a mailing address, a point of interest, a map portion, and so on, even when the coordinate does not precisely correspond to the geographical feature's location.

The friend finding module 128 may also format client location information provided by the client device 104 for use by the various friend finding services 108. In embodiments, the friend finding module 128 may receive client location information from the client device 104 in any format (e.g., geocoded coordinates) and convert the location information received from the client device 104 into a format suitable for use by one or more of the friend finding services 108 (e.g., into a mailing address, a latitude and longitude, a general location as discussed above, or into another coordinate system).

The friend finding module 128 may also translate information other than the location of a user or friend (e.g., a device associated with the user or friend) as discussed above. In embodiments, the friend finding module 128 may translate user identification information, status information, photograph formats, audio, video, and so forth that is exchanged between the client device 104 and the friend finding services 108 and/or friend devices 112. For example, in the implementation illustrated in FIG. 1, a first friend finding service 108(1) may identify users by email address, while a second friend finding service 108(2) may identify users by phone number. The friend finding module 128 may be operable to identify the user identification information (e.g., email address, phone number, etc.) required by the friend finding services 108 and select the appropriate information for provision to the friend finding services 108. The friend finding module 128 may also be operable to acquire user identification information from the various friend finding services 108 and translate the acquired information into a format suitable for use by the client device 104.

The functionality of the friend finding module 128 enables the server compatibility to be modified, such as by adding new friend finding services, without updating software on the client device 104. Thus, for example, the friend finding module 128 may be updated to interface with new friend finding services without providing an update to the client device 104. Such functionality enables the client device 104 to access a wide variety of friend information even in the face of changing and growing social networks.

In FIG. 1, the client device 104 is illustrated as including the user interface module 130, which may be implemented as a software application stored in memory 120 and executed by the processor 116 of the client device 104. The user interface module 130 provides functionality to exchange friend location information, identification information, and so on, with the friend finding module 128 of the server 102, and to furnish a user interface for communicating information to the user of the client device. In embodiments, the user interface module 130 may be configured as a graphical user interface (GUI) that allows display of text and graphical information such as maps, photographs, and so on.

The user interface module 130 further provide functionality to integrate friend location information into other client device 104 applications, such as a contact book, a calendar function, an email client, an instant messaging application, combinations thereof, and so on. For example, the user interface module 130 may automatically create phone and email contacts using friend information acquired by the server 102 without having the user manually enter contact information. The user interface module 130 may also allow the user to issue invitations to contacts found within the contact book or other client device 104 applications without having the user submit a specific invitation query as discussed above.

The user interface module 130 may also provide alerting functionality based on the location of the client device 104 and the location of one or more friend devices 112. For example, the user interface module 130 may cause the client device 104 to issue an alert to the user (e.g., by displaying a visual indicator on the display of the client device 104, causing an audio alert, such as a beep or ringtone, a recorded or synthesized segment of speech (the friend's name), and so on) to indicate that one of the user's friends is within a certain range from the user (e.g., 1 mile, 5 miles, or a user specified range). The user interface module 130 may receive input from the user to designate the friends (e.g., friend devices 112) for whom an alert is to be issued, and the range at which the alert is to be provided.

In an implementation, geo-tagged photographs (e.g., photographs that include location information) may also be exchanged between the client device 104 and the friend devices 112. For example, the client device 104 may be provided with a camera to take photographs which may be stored in memory such as memory 120 of the client device 104. The user interface module 130 may be operable to cause one or more of the photographs (which may or may not be geo-tagged) to be transmitted to the server 102. The friend finding module 128 of the server 102 may then forward the photographs to the various friend finding services 108 in addition to, or instead of, the location information and other information discussed above. The friend finding module 128 may also deliver photographs received from friend devices 112 through one or more of the friend finding services 108 to the client device 104 for storage in memory 120 and/or display by the user interface module 130 or another application of the client device 104.

In one embodiment, the user interface module 130 may be configured to cause the camera to automatically take photographs at predetermined intervals (e.g., at regular intervals, at predetermined geographic locations, and so on). The photographs may be geo-tagged with location information from the location determining system 126 and transmitted to the server 102. The photographs may then be distributed to one or more friend devices 112 by the friend finding module 128 via one or more of the friend finding services 108, e.g., at the same interval they were taken.

In an implementation, the friend finding module 128, in combination with the user interface module 130, may be operable to provide child tracking functionality to enable the user of the client device 104 to locate and/or track the user's children, e.g., who are using friend devices 112. Such child tracking functionality may include, for example, alerting the user of the client device 104 when a child's friend device 112 exceeds a certain speed threshold (e.g., a posted speed limit if the child is in an automobile); when a child's friend device 112 leaves or enters a certain geographic area or point of interest (e.g., a school); when the child's friend device 112 comes within a certain proximity to other friend devices 112 or the client device 104 itself; when the child's friend device 112 reaches a designated destination; combinations thereof, and so on.

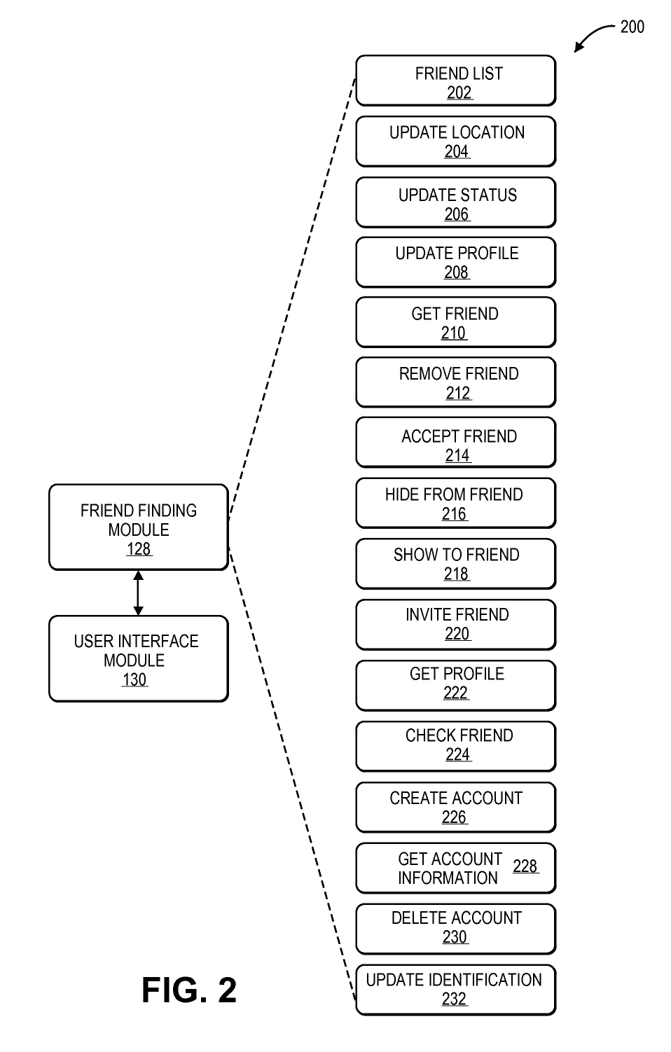

FIG. 2 illustrates example functionality 200 that may be implemented by the friend finding module 128 of the server 102, in combination with the user interface module 130 of the client device 104, shown in FIG. 1. As illustrated, the friend finding module 128 comprises a friend list module 202, an update location module 204, an update status module 206, an update profile module 208, a get friend module 210, a remove friend module 212, an accept friend module 214, a hide from friend module 216, a show to friend module 218, an invite friend module 220, a get profile module 222, a check friend module 224, a create account module 226, a get account information module 228, a delete account module 230, and an update identification module 232.

The friend list module 202 is representative of functionality to return a list of friends of the user to the client device 104 as a friend list. The friend list may include friends designated as trusted friends, invited friends, and/or pending friends. Trusted friends may comprise friends with whom the user already shares location information. Invited friends comprise friends to whom the user has sent a location sharing invitation, who have not responded to the invitation. Pending friends comprise friends from whom the user has received a location sharing invitation to which the user has not yet responded.

The friend list module 202 may retrieve the user's most recent friend list, including the most recent location and/or status updates of trusted friends and any new friend invitations. For example, the friend finding module 128 may, automatically or upon receiving a request from the client device 104, poll the friend finding services 108 to determine the location and/or status of various friend devices 112. This location/status information may be returned to user interface module 130 of the client device 104 for display to the user of the client device 104.

The update location module 204 is representative of functionality to update the location information of the client device 104 by determining the current location (e.g., latitude and longitude) of the device 104. The location of the client device 104 may be provided to one or more of the friend devices 112 of trusted friends of the user. For example, as shown in FIG. 1, user interface module 130 may receive the user's current location from the location determining system 126. The user interface module 130 may then cause location information describing the location to be provided to the friend finding module 128 of the server 102, which in turn provides the location to the various friend finding services 108 or the friend devices 112 directly.

The update status module 206 is representative of functionality to update the status of the user of the client device 104. The status may then be viewed by friends who have permission to view the user's status information. For example, as shown in FIG. 1, the user interface module 130 of the client device 104 may allow the user to create a status message (e.g., “Eating BBQ,” “Working,” “Sleeping,” “Traveling north on Main Street,” etc.) for distribution by the friend finding module 128 of the server 102 to the friend finding services 108.

The update profile module 208 is representative of functionality to create and/or update a user profile for the user of the client device 104. For example, the user may update the user profile for distribution by the friend finding module 128 to the friend finding services 108. The profile may include name, email address, phone number and other user information.

The get friend module 210 is representative of functionality to return detailed information for either the user or a single friend of the user's friend list. The information returned may include the most recent location and/or status of the user or friend (e.g., for trusted friends). For example, the friend finding module 128 may, automatically or upon receiving a request from the user, poll the friend finding services 108 to determine the location and/or status of the friend device 112.

The remove friend module 212 is representative of functionality that may be called to remove a specified friend from the user's friend list. The remove friend module 212 may be called to remove each of the various types of friends (e.g., trusted friends, pending friends, or invited friends) from the friend list. When the remove friend module 212 is called to remove a trusted friend, the module 212 may delete the friend from the user's friend list. When the remove friend module 212 is called to remove a pending friend, the module 212 declines the pending invitation from that friend. When the remove friend module 212 is called to remove an invited friend, the module 212 withdraws the invitation the user sent to that friend.

The accept friend module 214 is representative of functionality that may be called to accept a pending friend invitation from a friend. For example, the friend finding module 128 may receive an invitation from one or more of the friend finding services 108 to add the user of the client device 104 as a friend. The friend finding module 128 may cause the invitation to be pushed to the client device 104 for acceptance by the user.

The hide from friend module 216 is representative of functionality that may be enabled by the user of the client device 104 to hide the location of the client device 104, and thus the user, from friends associated with the various friend finding services 108. In this manner, when a friend of the user causes his or her friend device 112 to load a friend list, the friend is not allowed to see the location of the user (e.g., the location of the client device 104), even though the friend may still be allowed to see other information such as the user's status. Thus, by receiving a hide request from the user interface module 130 of the client device 104, the friend finding module 128 provides a way to hide location and/or status information from friends without removing the friends from the user's friend list.

The show to friend module 218 is representative of functionality that may be enabled by the user of the client device 104 to reveal the location of the user (e.g., the location of the client device 104) to trusted friends on the user's friend list (e.g., thereby reversing a hide request).

The invite friend module 220 is representative of functionality that may be enabled by the user of the client device 104 to send an invitation from the user to a specified friend. When the friend causes his or her friend device to call a friend list, the user will be shown as a pending friend on the friend list. In embodiments, the friend finding module 128 may send invitations directly to friend devices 112 by electronic mail, instant message, SMS, and so on, or may send invitations to the friend finding services 108 for distribution to the friend devices 112.

The get profile module 222 is representative of functionality that may be called by the user of the client device 104 to obtain the profile of a friend. For example, when the friend is specified and trusted, the friend's profile information, including information, such as the friend's phone number, first name, last name, and email address which are public, is returned by the friend finding module 128 to the client device 104.

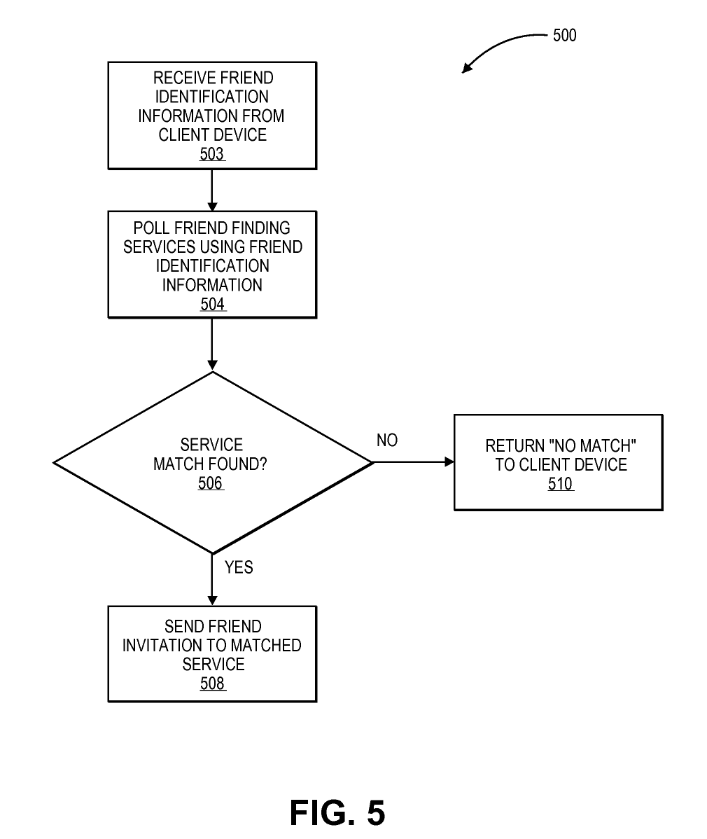

The check friend module 224 is representative of functionality to determine when a friend (e.g., a friend device 112) is associated with one or more of the friend finding services 108. For example, the user may input friend identification information such as a phone number, an email address, a username, a mailing address, a city or location associated with the friend, or other identifying information for the friend into user interface module 130 of the client device 104, which transmits the information to the friend finding module 128 of the server 102. The check friend module 224 may utilize the information received from the client device 104, in combination with any other information, to poll the friend finding services 108 to determine whether the friend device 112 is associated with any of the friend finding services 108. When a determination is made that the friend device 112 is associated with one or more of the friend finding services 108, the friend may be sent an invitation via the invite friend module 220 as discussed above. Such polling functionality enables the user to add friends to user's friend list without knowing the particular friend finding service 108 to which the friends belong and without knowing the contact information required to locate a friend using the various friend finding services 108. An example procedure that may be implemented by the check friend module 224 to locate friends on one or more friend finding services is described in FIG. 5.

The create account module 226 is representative of functionality to create an account for the user of the client device 104 on one or more of the various friend finding services 108. For example, the user may provide identifying information to the user interface module 130 of the client device 104, such as a phone number, an email address, a username and password, and so forth, which shares the identifying information with the friend finding module 128 of the server 102. The friend finding module 128 may use the identifying information to create accounts on the various friend finding services 108 on the user's behalf. For instance, where the friend finding module 128 is configured to allow communication with a number of friend finding services 108, an account may be created on each of the services 108 by the friend finding module 128 by having the user enter the user's identification information into the client device 104. In some embodiments, the create account module 226 may automatically create accounts for the user based on the client device's known phone number without entry by the user of any further identifying information.

The get account information module 228 is representative of functionality that may be called by a user of the client device 104 to obtain the user's account information on one or more of the services 108 for display by the client device 104. Example account information that may be obtained includes a user identification, security tokens, and so forth.

The delete account module 230 is representative of functionality that may be called by a user of the client device 104 to cause the user's account to be deleted on one or more of the services 108 by the friend finding module 128. Deletion of the user's account may include deletion of the user's friend list.

The update identification module 232 is representative of functionality to change the identification information of the user. For example, a telephone number may be assigned to the client device 104. This telephone number may be used by the friend finding module 128 to identify the user. Since the user may change the telephone number of the client device 104 (or, replace the client device 104 with a new device having a different telephone number), the update identification module 232 may be called to update the identification of the user when the user changes the telephone number assigned to the client device 104.

In FIG. 2, the friend finding module 128 is illustrated as including a plurality of modules configured to implement various functionality of the friend finding module 128. However, it is contemplated that other functionality and thus other modules may be provided. Further, it is contemplated that the functionality may be implemented in the server 102, such as by the friend finding module 128; in the client device 104 alone, such as by the user interface module 130; or may be distributed between the server 102 and the client device 104, such as between the friend finding module 128 and the user interface module 130.

Generally, any of the functions described herein can be implemented using software, firmware, hardware (e.g., fixed logic circuitry), manual processing, or a combination of these implementations. The terms “module” and “functionality” as used herein generally represent software, firmware, hardware or a combination thereof. In the case of a software implementation, for instance, the module represents executable instructions that perform specified tasks when executed on a processor, such as the processors 114 & 116 of the server 102 and client device 104, respectively, of FIG. 1. The program code can be stored in one or more computer readable media, an example of which is the memory 118 & 120 of the server 102 and client device 104, respectively, of FIG. 1. The features of the techniques to stream information describing a webpage described below are platform-independent, meaning that the techniques may be implemented on a variety of commercial computing platforms having a variety of processors.

Example Procedures

The following discussion describes techniques to exchange location information between a location-aware client device and friend devices via a server that is configured to communicate the location information with the friend devices through one or more friend finding services. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1 and the functionality 200 of FIG. 2.

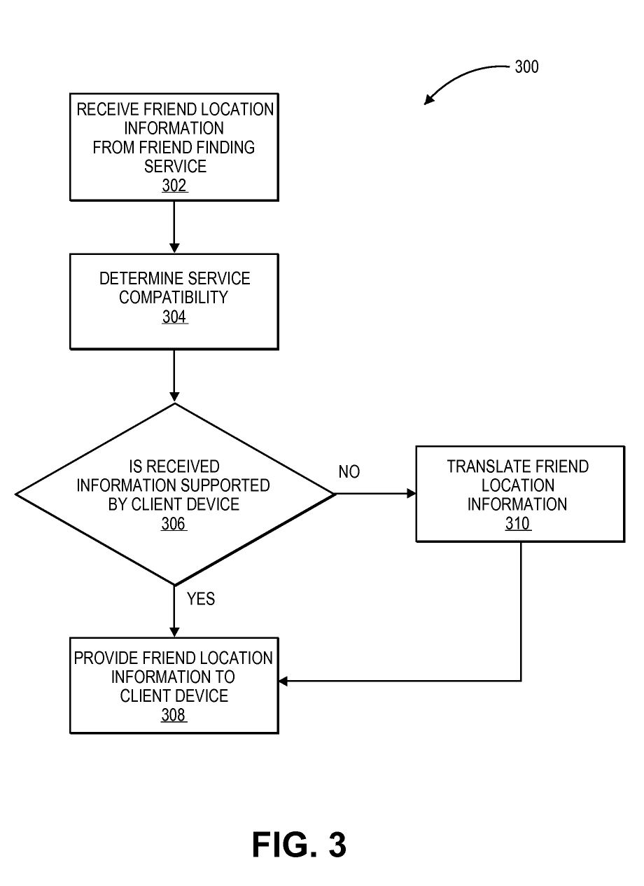

FIG. 3 depicts a procedure 300 in an example implementation in which friend location information for friend devices is retrieved from one or more friend finding services and furnished to a client device. As illustrated, friend location information for a friend device is received from a friend finding service 108 (block 302). For example, the server 102 illustrated in FIG. 1 may be configured to acquire location, user, or other information for friend devices 112 from the various friend finding services 108 or directly from the friend devices 112 as shown in FIG. 1.

Compatibility of the friend finding service is next determined (block 304). As illustrated, a determination may be made whether the friend location information received from the friend finding service is supported by the client device (decision block 306). In embodiments, the server 102 may access friend finding services 108 that utilize location information formatted in a variety of different formats. It is contemplated that the client device 104 may support some, but not all, formats that may be encountered. For example, a first friend finding service 108(1) may be configured to utilize location information formatted as geographic coordinates (e.g., latitude and longitude), while a second friend finding service 108(2) may be configured to utilize unsophisticated location information (e.g., a mailing address, a general location such as a restaurant name, and so on). The client device 104 may be configured to support location information received in geographic coordinates, but not unsophisticated location information. Thus, the first friend finding service 108(1) may be determined to utilize location information having a format that is compatible with (e.g., supported by) the client device 104, while the second friend finding service 108(2) may be determined to utilize location information having a format that is not compatible with (e.g., supported by) the client device 104.

When the received friend location information is determined to be supported by the client device (“yes” from decision block 306), the location information is provided to the device (block 308). However, when the received friend location information is determined to not be supported by the client device (“no” from decision block 306), the location information is translated into a format that is supported (block 310). For instance, in the example described above, location information for friend devices 112 received from the first friend finding service 108(1) may be passed to the client device 104 by the server 102 without translation since the format of the location information is supported by the client device 104. Conversely, location information for friend devices 112 received from the second friend finding service 108(2) is first translated from the unsophisticated format into geographic coordinates so that the location information is fully supported by the client device 104. In embodiments, a variety of techniques may be employed to translate the location from a first, unsupported, format into a second, supported, format. For example, as discussed in relation to FIG. 1, map matching and other location-conversion functionality may be employed to translate unsophisticated location information into sophisticated location information. Further, sophisticated location information associated with the services 108 may be translated into sophisticated location information that is most suitable for use by the device 104. For example, one of the services 108 may provide geocoded information in a first format not utilized by the client device 104 and the server 102 may translate the geocoded information from the first format to a second format suitable for use by the device 104. Such functionality enables the friend finding module 128 to adapt to changing or new location formats without requiring a software update for the client device 104. The translated friend location information is then provided to the client device (block 308).

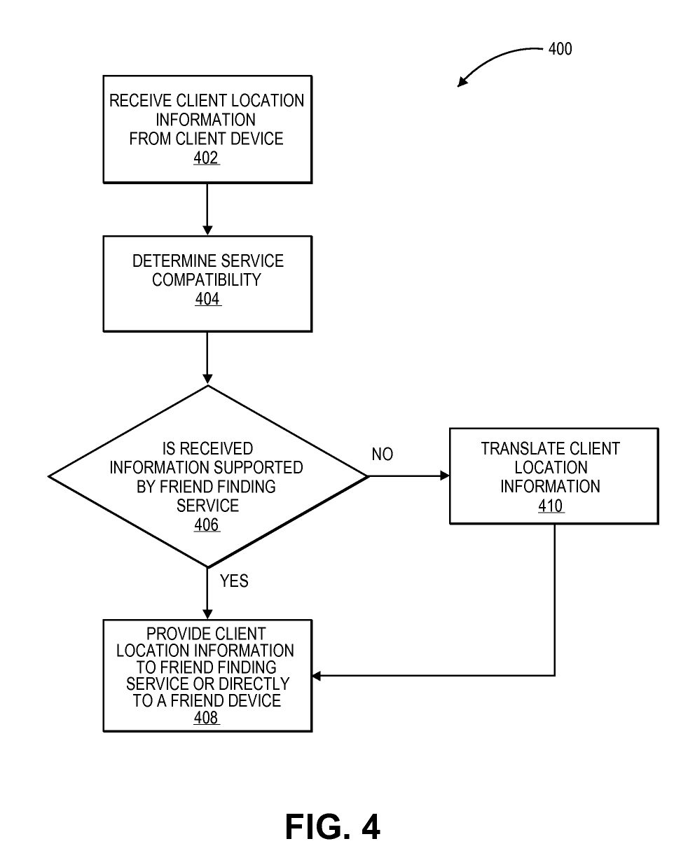

FIG. 4 depicts a procedure in an example implementation in which client location information for a client device is furnished to a friend device via one or more friend finding services. As illustrated, client location information is received from the client device (block 402). For example, the client device 104 may automatically push location information to the server 102 at various intervals or in response to a manual input by a user of the client device 104.

Compatibility of the friend finding service is next determined (block 404). As illustrated, a determination may be made whether the client location information received from the client device is supported by the friend finding service (decision block 406). In embodiments, the client device 104 may provide location information in a predetermined format (e.g., geographic coordinates or other geocoded information). However, the user of the client device 104 may desire to share the location information with friend devices 112 employing friend finding services 108 that utilize location information formatted in a variety of different formats. For example, in the example discussed in relation to FIG. 3, the first friend finding service 108(1) may be determined to be compatible with the client device 104, while the second friend finding service 108(2) is determined to not be compatible.

When the received client location information is determined to be supported by the friend finding service (“yes” from decision block 406), the location information is provided to the service for delivery to the friend device or directly to the friend device itself (block 408). However, when the received client location information is determined to not be supported by the friend finding service (“no” from decision block 406), the location information is translated into a format that is supported (block 410). For instance, in the example described above, location information received from the client device 104 may be passed to the first friend finding service 108(1) by the server 102 without translation since the format of the location information is supported by the service 108(1). Conversely, location information received from the client device 104 is first translated from geographical coordinates to the unsophisticated format so that the location information is supported by the second friend finding service 108(2). As described above, a variety of techniques such as map matching may be employed to translate the location from a first, unsupported, format into a second, supported, format. The translated client location information is then provided to the friend finding service or directly to a friend device (block 408).

FIG. 5 depicts a procedure 500 in an example implementation in which friend devices may be located on one or more friend finding services. As illustrated, friend identification information is received from the client device (block 502). For example, the user may input a phone number, an email address, a username, a mailing address, or other identifying information for a friend into the client device 104, which transmits the information to the server 102. One or more friend finding services may then be polled to locate the friend device using the friend information (block 504). For example, the server 102 may utilize the information provided from the client device 104, in combination with any other information, to poll the friend finding services 108 that may be accessed by the server 102 to determine whether the friend is associated with any of the friend finding services 108.

A determination is then made whether a friend device has been found that matches the friend information (decision block 506). When a determination is made that a friend device has been found (“yes” from decision block 506), a friend invitation may be sent (block 508). However, if a determination is made that no match is found (“no” from decision block 506), a message is returned to the client device (block 510) indicating that no friends could be found.

Example Client User Interfaces

This section presents elements of user interfaces that may be generated using the processes and techniques discussed herein to exchange location information between a location-aware client device 104 and one or more friend devices 112. Aspects of the user interface may be generated by hardware, firmware, software or a combination thereof. In portions of the following discussion, reference will be made to the environment 100 of FIG. 1, the functionality 200 of FIG. 2, and the procedures 300, 400 and 500 of FIGS. 3, 4, and 5, respectively, and/or other example environments and procedures.

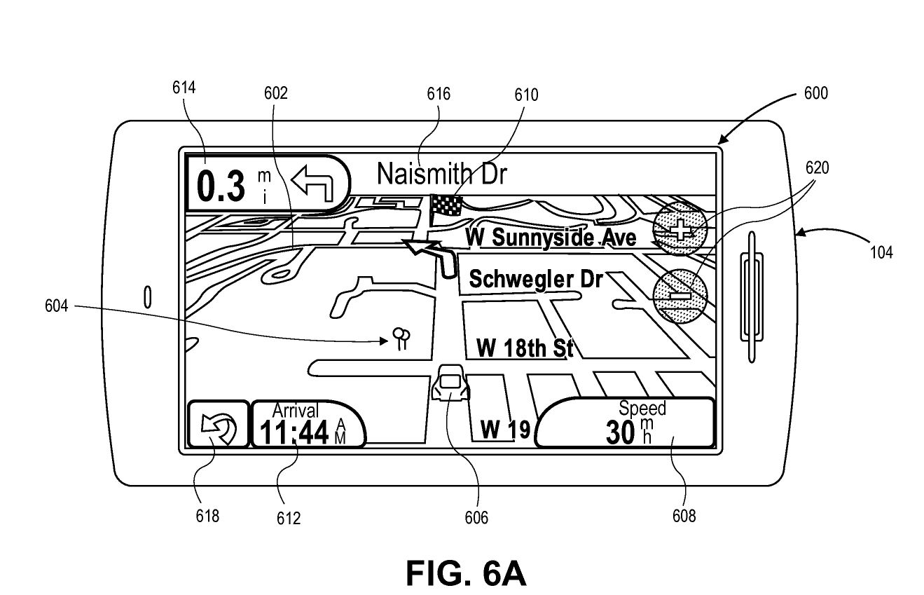

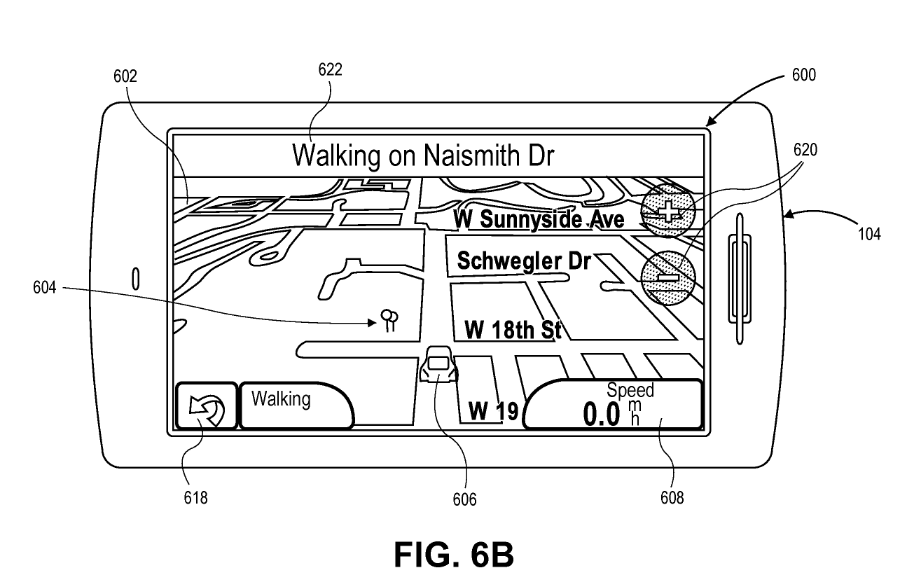

FIGS. 6A and 6B depict an example user interface 600 of a client device, such as the client device 104 shown in FIG. 1, in which a location of a friend device is shown on a map displayed by the user interface. As illustrated, the user interface 600 may be configured to display a moving map display 602. The location of one or more friends may be displayed on the moving map display 602 using at least one friend icon 604. The location of the user may similarly be displayed as a user icon 606 such as an automobile graphic, an arrow, and so forth. As the user moves about, the moving map display 602 may change to reflect the user's changed location, and the location of nearby friends may be automatically displayed as friend icons 604 displayed on the map display 602. Similarly, as nearby friends of the user move about and new location information is received, the positions of friend icons 604 representing those friends within the map display 602 may change to reflect the changed locations of the friends. In this manner, the user may be apprised of the location of the user's friends (e.g., the location of the friend's friend devices 112) without navigating through a series of menu pages or other links displayed by the client device 104.

In embodiments, the map display 602 may include a variety of indicia configured to aid a user of the client device 104 in navigating to a destination. For example, FIG. 6A depicts the user interface 600 as providing a map display 602 that is configured to furnish navigation to the user, such as while the user is driving an automobile. Thus, the map display 602, may include indicia configured to display the speed the user (e.g., the client device 104) is moving 608, an icon representing the user's destination (e.g., a “checkered flag”) 610, an estimated arrival time at the user's destination 612, an indication of the distance to and direction of the user's next turn 614, the name of the street that the user is currently traversing 616, a back button 618, map zoom icons 620, and so forth.

Similarly, FIG. 6B illustrates the user interface 600 that is configured to provide location and status information without navigation. As shown, the map display 602 may include indicia configured to display the speed the user (e.g., the client device 104) is moving 608, the status of the user (e.g., “Walking on Naismith Dr”) 622, back button 618, map zoom icons 620, and so on. Other configurations of the map display 602 are contemplated.

In implementation, the map display 602 of the user interface 600 may function as a principal display presented by the client device 104. By displaying friend icon 604 depicting the location of a friend in relation to the map display 602, the user interface 600 permits the user to quickly ascertain the locations of the friends. Further, on the map display 602, the user may select the friend icon 604 to identify the friend associated with the icon 604, retrieve information regarding the friend (e.g., status information, address information, and so forth), and be presented with communication options (e.g., initiate a phone call, an SMS, an email, etc.) and/or navigation option (e.g., routing) regarding the friend.

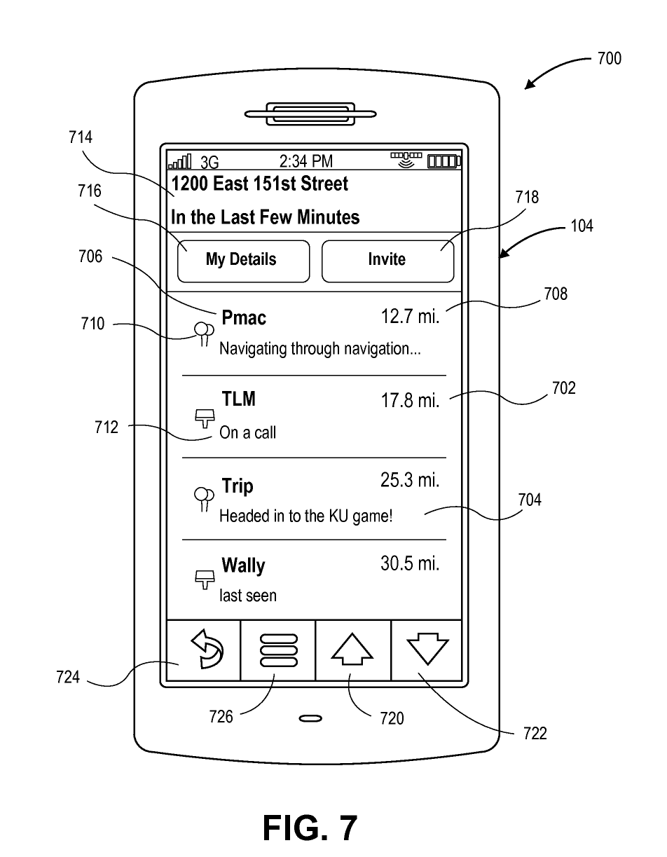

FIG. 7 depicts an example user interface 700 of a client device, such as the client device 104 shown in FIG. 1, in which a list of friend devices 112 is displayed. As illustrated, the user interface 700 may display a friend list 702 containing a list of entries 704 corresponding to the user's friends (e.g., friend devices 112) sorted based on the distance of the friends from the user (e.g., the client device 104). Entries 704 within the friend list 702 may provide a variety of information related to the identity and/or status of the friends represented. For example, entries 704 within the friend list 702 may indicate the name of the friend 706, the distance of the friend from the user 708, the friend finding service the friend is using (e.g., via a network icon 710 configured to identify the network), and the status of the friend 712 (e.g. “On a call”). Other information may be furnished by the friend list 702.

As shown in FIG. 7, the user interface 700 may be configured to display other information and controls. As illustrated, the user interface 700 may display the current location 714 of the user. In embodiments, the current location 714 of the user may comprise the location of the client device 104 as determined by the location determining system 126 (FIG. 1), which may be converted to an address using map matching techniques.

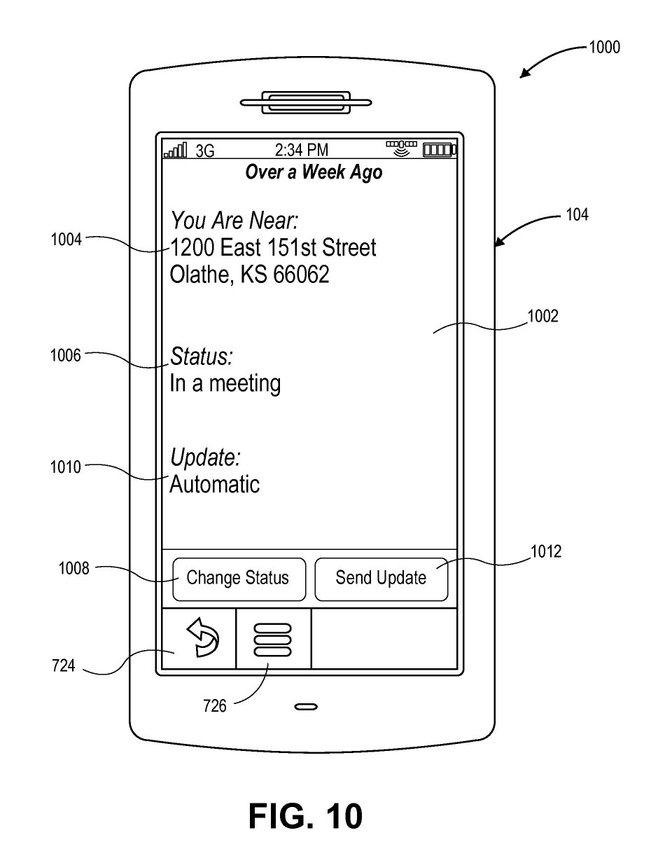

Additionally, controls may be provided to allow the user of the client device 104 to obtain additional information, such as location information, setting information, status information, and so forth, and to invite friends for inclusion in the friend list 702. For example, the user interface 700 is illustrated as including a “My Details” button 716 and an “Invite” button 718. The My Details button 716 may be configured to cause a status page to be displayed to furnish the status of the user and/or the client device 104 (see FIG. 10). The Invite button 718 may be configured to cause an invitation to be sent to a friend device 112 inviting friend to be added to the user's friend list 702, e.g., by initiating the invite friend module 220 illustrated in FIG. 2.

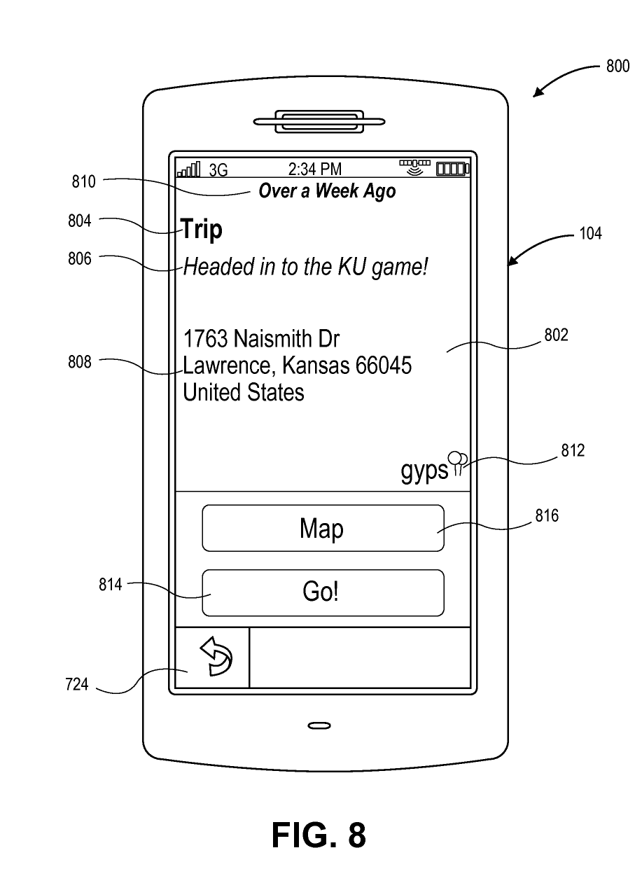

Further, controls may be provided to provide navigation functionality to allow the user to navigate among entries 704 of the friend list 702. For example, the user interface 700 is depicted as including up and down scroll buttons 720 & 722 that are configured to scroll the entries 704 of the friend list 702, a back button 724 that is configured to return the display to a prior user interface, such as the user interface 600 illustrated in FIGS. 6A & 6B, and a menu button 726 that may be configured to provide additional menu functionality (e.g., menu navigation, jumping to a main menu, and so forth). The back and menu buttons 724 & 726 may likewise be presented in user interfaces accessed through the user interface 700 in FIG. 7, e.g., user interfaces 800, 900 & 1000 shown in FIGS. 8, 9, and 10, respectively.

In an implementation, the selection of an entry 704 from the friend list 702 may cause additional information related to and/or describing the selected friend to be displayed. Example information that may be displayed may include routing options, navigation options (e.g., displaying a map of the friend's location and/or points of interest near the friend's location), communication options, and so on. FIG. 8 depicts an example user interface 800 in which friend information 802 is displayed that describes a friend corresponding to an entry 704 selected from the friend list 702 shown in FIG. 7. As illustrated, the user interface 800 may provide a variety of information related to the identity and/or status of the friend. For example, the user interface 800 may indicate the name of the friend 804 (which may be the friend's formal name, first name, last name, a username, a nickname, and so on), the status of the friend 806 (e.g., “headed to the KU game”), the nearest address to the friend 808 which may be determined using the matching techniques, a date and/or time the status was last updated 810, an identifier of the friend finding service used by the friend device 812, and so forth.

The user interface 800 may further include controls that allow mapping and navigation functionality to be provided to the user. For example, the user interface 800 is depicted as including “Go!” and “Map” buttons 814 & 816. In embodiments, selection of the “Go!” button 814 may cause a route to be calculated from the current location of the user (e.g., the current location of the client device 104) to the location of the friend (e.g., the location of the friend device 112). The route may be displayed on a moving map display, such as the moving map display 602 of the user interface 600 shown in FIGS. 6A and 6B. In such embodiments, the friend's location becomes the destination 610.

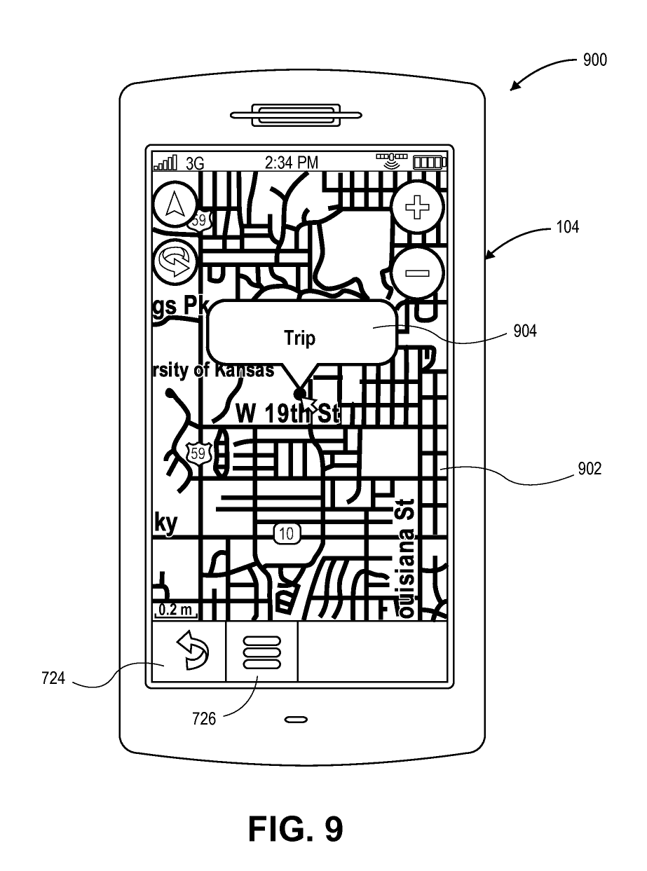

Selection of the “Map” button 816 may cause a map surrounding the friend's current location 808 to be presented. FIG. 9 depicts an example user interface 900 in which a map 902 illustrating an area surrounding location of a friend (e.g., a friend device 112) is displayed. As illustrated, a friend icon 904 identifying the friend may be displayed on the map 902 at the location of the friend. The friend icon 904 may be selected by the user of the client device 104 to acquire additional information regarding the selected friend. Additionally, selection of the friend icon 904 may cause navigation functionality to be made available, such as the display of a user interface 600 described in relation to FIGS. 6A and 6B.

In an implementation, the user interface 800 may integrate with one or more communication applications of the client device 104 to furnish communication functionality without navigating away from the map 902. For example, the user of the client device 104 may select the friend icon 904 to initiate communication functionality with the friend, such as sending an electronic mail message, sending an SMS text, initiating a phone call, so on. The user may also select a friend, by selecting the friend icon 904 from the map 902, to initiate search functionality to search for points of interest, or other information, located in proximity to the friend or in other areas associated with the location of the friend and the client device 104, such areas between the two locations.

FIG. 10 depicts an example user interface 1000 of a client device, such as the client device 104 shown in FIG. 1, in which the status of the user of the client device 104 is displayed. As illustrated, the user interface 1000 comprises a status page 1002 configured to provide a variety of status information for the user of the client device 104. For example, the status page 1002 is illustrated as indicating the user's current location 1004 (e.g., “You Are Near: 1200 E. 151^{st} St., Olathe, Kans. 66062”) and current status (e.g., “Status: In a meeting”) 1006. In embodiments, the current location 1004 may be provided as an address, which may be determined using the map matching techniques. The current status 1006 may be entered by the user. For example, the user interface 1000 may include a control (e.g., “Change Status” button 1008) that may be selected by the user to enter or select a new status.

The status page may also display an update configuration setting 1010 (e.g., “Update: Automatic”) to indicate the manner in which the user's location and status information are to be updated for distribution to the various friend finding services 108 of FIG. 1. In embodiments, the update configuration setting 1010 may provide a number of options to the user for updating the user's location and status information. For example, the user's location and status information may be automatically provided to the server 102 by the client device 104. The server 102 may distribute the location and status information to the various friend finding services 108 by the server 102 to apprise the user's friends, via friend devices 112, of changes to the information.

The user's location and status information may also be manually updated by the user. For example, the user may wish to prevent the client device 104 from sharing the location and status information with the server 102 and the friend finding services 108, unless specifically commanded to do so, for example, due to privacy concerns. As shown, the user interface 1000 may include a control (e.g., “Send Update” button 1012) that may be selected by the user to cause location and status information to be provided to the server 102 for distribution to friend devices 112 through the various friend finding services 108.

In some embodiments, the client device 104 may employ friend information acquired from the server 102 and/or the various friend finding services 108 with other applications executed by the client device 104 beyond the friend finding functionality discussed herein. For example, the client device 104 may populate an address book, a calendar, a phone book, an email database, and/or any other contact database with friend information, such as a friend's name, phone number, mailing address, and email address, without requiring the user to manually enter the contact information. Thus, the user of client device 104 may populate a contact database simply by issuing friend invitations as discussed above. In some configurations, the client device 104 may include a centralized contact database that may be used by any application to access contact information. The centralized contact database may be automatically populated as discussed above without tiresome manual entry of friend information.

In embodiments, the client device 104 and/or the server 102 may employ map matching techniques to match the user's location to a corresponding point of interest (e.g., a restaurant where the user is located). The server 102 may then provide the point of interest to the various friend finding services 108 for distribution to the user's friends (e.g., friend devices 112). Such functionality may be desirable, for example, where the friend devices 112 lack navigation capabilities.

The server 102 and/or the client device 104 may also integrate advertising information for display to the user. For example, the client device 104 may be configured to present advertisements for businesses and services that are located in proximity to the user, the user's friends, or areas there between on one or more of the user interfaces of the client device 104, e.g., user interfaces 600, 700, 800, 900, & 1000 of FIGS. 6, 7, 8, 9, and 10, respectively. In embodiments, these advertisements may be provided to the client device 104, by the server 102, an advertising server, a friend finding service 108, a friend device 112, and so on.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A friend finding server operable to provide friend location information to a client device, the server comprising:
a network interface operable to communicate with the client device through a first network and communicate with a plurality of friend finding services through a second network;
a memory including a friend finding module; and
a processor coupled with the network interface and the memory, the processor operable to execute the friend finding module to:
receive friend location information having a first format from at least one of the friend finding services,
determine whether the received friend location information is supported by the client device,
convert the friend location information from the first format into a second format that is supported by the client device when the friend location information is determined not to be supported by the client device, and
provide the converted friend location information to the client device through the network interface.

2. The friend finding server of claim 1, wherein the processor is operable to execute the friend finding module to:
receive client location information from the client device through the network interface, the received client location information having the second format,
determine whether the received client location information is supported by a first one of the friend finding services,
convert the client location information from the second format into the first format when the client location information is determined to not be supported by the first friend finding service, and
provide the converted client location information to the first friend finding service through the network interface.

3. The server of claim 1, wherein converting the friend location information from the first format into the second format comprises performing map matching of the received friend location information.

4. The server of claim 1, wherein the received friend location information formatted in the first format comprises unsophisticated location information and the friend location information formatted in the second format comprises geocoded coordinates, and wherein converting the friend location information from the first format into the second format comprises converting the unsophisticated location information into geocoded coordinates.

5. The server of claim 1, wherein the friend location information includes identification information configured to identify the friend.

6. The server of claim 1, wherein the friend location information comprises status information configured to furnish a status of the friend.

7. The server of claim 1, wherein the first network is the same as the second network.

8. The server of claim 1, wherein the processor is operable to execute the friend finding module to:
receive friend identification information from the client device through the network interface, the friend identification information configured to identify a friend of the client device;
poll at least one of the friend finding services through the network to identify which of the friend finding services include account information corresponding to the received friend identification; and
transmit a friend invitation to the identified friend finding service.

9. A friend finding server operable to provide friend location information to a client device, the server comprising:
a network interface operable to communicate with the client device through a first network and communicate with a plurality of friend finding services through a second network;
a memory including a friend finding module; and
a processor coupled with the network interface and the memory, the processor operable to execute the friend finding module to:
aggregate a listing of the friend finding services,
receive friend identification information from the client device through the network interface, the friend identification information configured to identify a friend of the client device,
poll at least one of the friend finding services through the network to identify which of the friend finding services include account information corresponding to the received friend identification, and
transmit a friend invitation to the identified friend finding service.

10. The server of claim 9, wherein the processor is further operable to execute the friend finding module to:
receive friend location information having a first format from at least one of the friend finding services,
determine whether the received friend location information is supported by the client device,
convert the friend location information from the first format into a second format that is supported by the client device when the friend location information is determined not to be supported by the client device, and provide the converted friend location information to the client device through the network interface.

11. The server of claim 10, wherein the received friend location information formatted in the first format comprises unsophisticated location information and the friend location information formatted in the second format comprises geocoded coordinates, and wherein converting the friend location information from the first format into the second format comprises converting the unsophisticated location information into geocoded coordinates.

12. The server of claim 9, wherein the processor is further operable to:
execute the friend finding module to determine if the identified friend finding service accepted the friend invitation; and
transmit to the client device an indication of the acceptance of the friend invitation.

13. A method comprising:
receiving client location information from a client device associated with a client to be furnished to a friend of the client via a friend finding service, the client location information having a first format;
determining whether the client location information is supported by the friend finding service in the first format;
converting the client location information from the first format into a second format that is supported by the friend finding service when the client location information is determined not to be supported by the friend finding service in the first format.

14. The method as recited in claim 13, further comprising causing the client location information to be furnished to the friend finding service in the first format if the client location information is supported by the friend finding service in the first format; else causing the client location information to be furnished to the friend finding service in the second format.

15. The method as recited in claim 14, further comprising:
receiving friend location information for the friend of the client from the friend finding service, the friend location information having the second format;
determining whether the friend location information is supported by the client device in the second format; and
converting the friend location information from the second format into the first format when the friend location information is determined not to be supported by the client device in the second format.

16. The method as recited in claim 13, wherein converting the client location information from the first format into the second format comprises performing map matching of the client location information.

17. The method as recited in claim 13, wherein the client location information formatted in the first format comprises geocoded coordinates and the client location information formatted in the second format comprises unsophisticated location information, and wherein converting the client location information from the first format into the second format comprises converting the geocoded coordinates into the unsophisticated location information.

18. The method as recited in claim 13, wherein the client location information includes identification information configured to identify the client.

19. The method as recited in claim 13, wherein the client location information includes status information configured to furnish a status of the client.

20. The method as recited in claim 13, wherein the client device comprises a location-aware mobile device.

21. The method as recited in claim 13, further comprising:
receiving friend identification information from the client device, the friend identification configured to identify an additional friend of the client;
polling the one or more friend finding services using the friend identification information to locate the additional friend; and
transmitting a friend invitation to the friend finding service if the friend is located.
